(19) United States
(12) Patent Application Publication
(10) Pub. No.: US 2003/0056450 A1
(43) Pub. Date: Mar. 27, 2003

(54) Window and door casing

(76) Inventor: Donald J. Bealko, Bedford, NH (US)

Correspondence Address: Norman P. Soloway, HAYES SOLOWAY P.C., 130 W. Cushing Street, Tucson, AZ, 85701, US

(21) Appl. No.: 10/287,962

(22) Filed: Nov. 5, 2002

Related U.S. Application Data
(62) Division of application No. 09/575,340, filed on May 19, 2000.

(51) Int. Cl. E06B 3/00; E04C 2/38; E04C 3/30

(52) U.S. Cl. 52/204.55; 52/730.4; 52/734.1; 52/656.2

(57) ABSTRACT

A window or door casing includes two side sections, a header or top section and bottom section. The bottom section also has caps attached at either end. The trim casing is mountable on a window or door frame and is securely fastened to the side of the house ensuring a tight fit and finished appearance.

### BACKGROUND OF THE INVENTION

The use of vinyl siding in place of wood, aluminum or other materials on the exterior of a house in new construction as well as remodeling has become quite prevalent. Such siding has historically been made of aluminum or wood. Window and door openings in the exterior wall of a house are generally trimmed with wood casings or moldings framing the window and providing an aesthetically finished exterior look. One version of such a window trim has been the “Eastern” casing. Typically, the window manufacturer attaches a 3-4″ wide board that is ¾ to 5/4″ thick to the face of the window jamb and ships the window with this feature applied. Alternatively, the builder constructs the wood casing at the site. The house siding, whether wood or vinyl, is fitted to or butted up against the trim casing. In the case of vinyl siding, a “J” channel is nailed to the wall board and the vinyl siding slides behind the face of the J channel. One problem with this, however, is that the wooden casings are not compatible with aluminum or vinyl siding. For example, the wood requires continued painting, defeating the maintenance-free advantages of vinyl siding, the appearance will be inconsistent, and wood against vinyl creates the potential for unsightly gaps because of their different thermal characteristics.

With the introduction of the vinyl window an Eastern casing trim option had not been available in an extruded vinyl add-on. Accordingly, builders desiring the aesthetics of an Eastern casing, were relegated to using wood and/or wood wrapped in aluminum cladding requiring custom fitting, a labor intensive and expensive process.

### BRIEF DESCRIPTION OF THE PRIOR ART

U.S. Pat. No. 4,193,238 describes a window casing cover comprised of trim molding members that snap onto a plurality of separate brackets that are individually attached to the original casing. Although the covers provides a maintenance free surface, the numerous components involved and the “do it yourself” appearance of the add-on side portions and coverings do not offer the structure and strength or appearance of an integrated component, nor is the problem of differing thermal expansion/contraction resolved.

U.S. Pat. No. 4,389,824 discloses window trim comprised of upper and side panels and a window sill covering. Each panel has a receiving strip which is fitted around the inside of the window casing and a substantially flat panel is bent at the site into an L-shaped configuration which is then fitted around the casing and overlies the siding. The receiving strip includes a spring held receiving slot for the L-shaped panel. U.S. Pat. No. 5,022,204 discloses a similar receiving strip and L-shaped facing strip in which the receiving strip may be attached to the front of the casing. Both of these approaches are time consuming to fabricate and install, are comprised of many components having different angles and fittings, and include the cumbersome method of using L-hooks screwed into the house to hold and align the strips.

A do-it-yourself kit of prefabricated components for retrofitting cladding over an existing door or window frame is disclosed in U.S. Pat. No. 5,669,192. The kit comprises sections for covering the side and the header surfaces of the existing trim. A lengthwise lip folds inward along one edge of each section and a lengthwise flange portion folds inward around the opposite edge of each such section, gripping the trim in frictional engagement. A J-strip exists around the frame, to retain the siding, the folded flange fitting between the J-strip and the siding. A drawback of this approach is that the use of friction to hold the cladding in place lacks stability and durability and will result in an inconsistent fit and appearance over time.

### SUMMARY OF THE INVENTION

It is therefore an object of this invention to provide a window and door casing for use with new construction as well as remodeling that is simple to fit and install, will provide a durable, secure and complete aesthetic finished look, and will not be subject to differing thermal characteristics. The trim casing is comprised of extruded portions or sections with an integral “J” channel built in providing superior aesthetic features; two side sections, a header or top section and, in the case of a window application a sill bottom section. The sill also has caps attached at either end. The trim casing is mountable on a window or door frame and is securely fastened to the side of the house ensuring a tight fit.

In the preferred embodiment, the casing is comprised of extruded vinyl, and comprises pre-mitered side sections and the header section include a rapid fastening system incorporating a screw boss in the extrusion coupled with a tongue-in-groove design on the inside edge which is received by an accessory groove (channel) with a flexing accessory lock incorporated on the sides of the window or door frame, and a nailing fin on the opposite side, and in the case of a window, an extruded attachable sill nosing which simulates the thick wood look having insertable end caps to cover the open ends and an integral flange to cover the meeting point of the side casing to the sill nosing.

A method of installing the casing consistent with the invention includes the steps of: in the case of new construction, first installing, leveling and squaring the window or door properly; securing the window or door by nails, staples or screws using the window's or door's nailing fin; pre-assembling the top section of the pre-mitered casing to the side casings, mating the angled ends thereof and then screwing the sections together; sliding the resulting three-sided “horseshoe” shaped assembly over the front of the window or door, the tongues of the assembly fitting into the accessory grooves located on the window or door frame. Then placing the tongue or flange of the sill section into the accessory groove on the bottom end of the window and snapping it onto place and/or tapping the assembly with a mallet to secure a snug fit, with the side sections also fitting behind flange at the meeting point of the side sections to the sill section and the end caps are fitted into the sides of the sill section. The sill section is then fastened to the side sections with screws and the casing is secured to the side of the house with nails using the attached nailing fins.

These and other objects, features and advantages of the present invention will be better understood with reference to the detailed description of the preferred embodiment and the accompanying drawings.

### BRIEF DESCRIPTION OF THE DRAWINGS

FIG. 1 is a perspective view of a window of a house and including the casing according to the present invention;

FIG. 2 is a perspective view of the assembled casing according to the invention;

FIG. 3 is perspective exploded view of the casing of FIG. 2;

FIG. 4a is a fragmentary perspective view of the upper right corner of the casing of FIG. 3;

FIG. 4b is a perspective view of the lower right corner of the casing of FIG. 2;

FIG. 4c is a fragmentary exploded perspective view of the lower right corner of the casing of FIG. 3;

FIG. 5 is a perspective of two sides of a window frame according to the present invention;

FIG. 5b is a fragmentary perspective view of an add-on accessory groove device;

FIG. 6 is a fragmentary perspective view of a sill of the casing according to the invention;

FIG. 7 is a fragmentary perspective view of an end cap of a sill of the casing according to the invention;

FIG. 8a is a side view of a sill mounted on the bottom of a window frame installed on a house showing the exterior siding;

FIG. 8b is an exploded side view of a sill and the bottom of a window frame;

FIG. 9 is a top elevational view of a sill mounted on the bottom of a window frame according to the invention;

FIG. 10a is a top plan view of a side casing section mounted on the side of the window frame installed on a house showing the exterior siding;

FIG. 10b is an exploded top view of a side casing section and the side of the window frame;

### DESCRIPTION OF THE PREFERRED EMBODIMENT

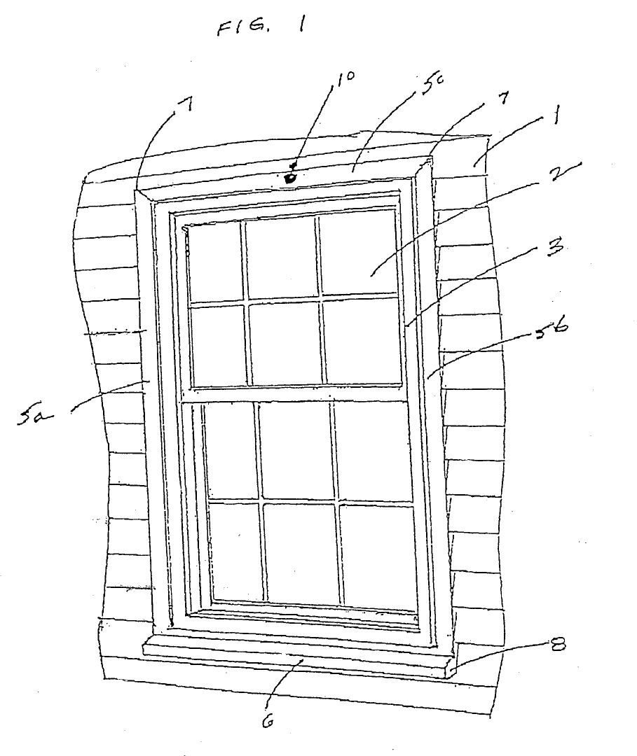

Referring to FIG. 1 is shown a preferred embodiment of an eastern casing 10 mounted on the window frame 3 of a window 2 installed on a house. In FIG. 2 the assembled casing 10 is shown independent of the window or house. In the preferred embodiment casing 10 is comprised of two side sections 5a and 5b, header or top section 5c and sill or bottom section 6 with end caps 8 attached at either end of the sill. The sections of the casing may be pre-cut for standard sized windows or may be custom cut in advance or at the site, for non-standard sized windows. Preferably, the casing 10 is comprised of extruded vinyl, although other materials such as aluminum, may be used. The top corners of side sections 5a and 5b are pre-mitered at 45° angles and meet flush with the ends of the top section 5c which are also pre-mitered at 45° angles at corners 7. It is appreciated that the mitered angles of the top and side sections may vary from 0-90° depending upon the aesthetic look desired or to combine with decorative caps or millwork, for example. It should also be understood that the same type of casing, with the exception of the sill, may be used in trimming a door or other opening.

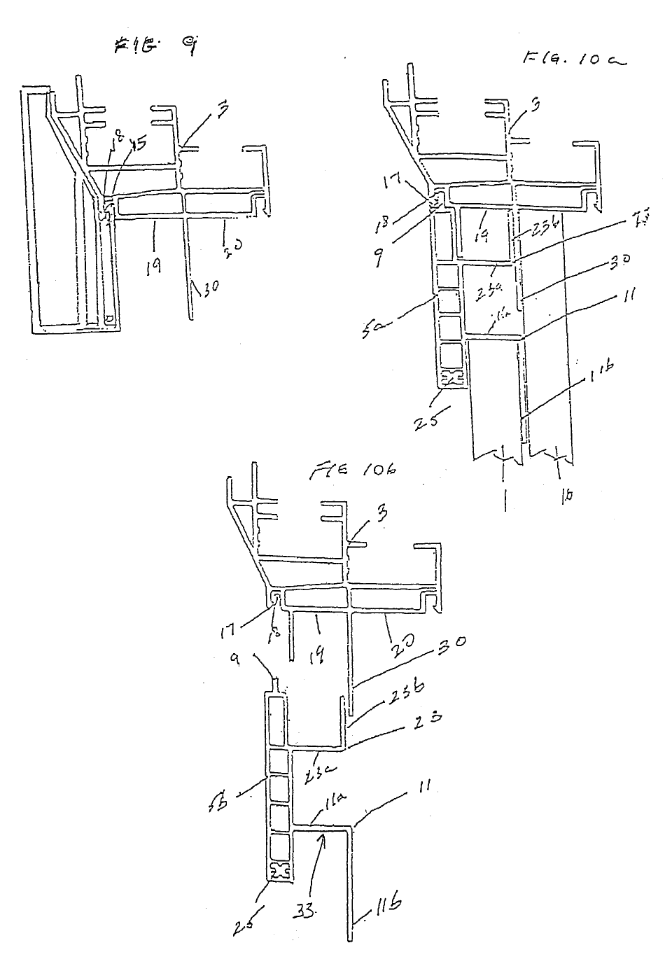

Referring now again to FIG. 2, nailing fins 11 are located on the outside edges of the side and top sections 5a, 5b and 5c. When the casing 10 has been mounted on the window, nailing fins 11 sit flush against the sheathing or other underlayer of the house and nails are driven through the plurality of slotted nail holes 12 extending the length of the nailing fins to further secure the casing to the house. Along the length of the inside edges of top and sides casings 5a, 5b and 5c are located tongues 9 to be received by accessory grooves or channels 18 inside the window frame 3 as shown in FIGS. 5, 10a and 10b. Along the inside edge of sill 6 is located a sill tongue 15 which is received by the accessory groove or channel 18a in the bottom of the window frame 3 as shown in FIGS. 8a, 8b and 9. Preferably, sill tongue 15 has a notch or flange at its upper end to overlap a flexible locking accessory 17 in accessory groove 18a in the bottom of the window frame. End caps 8 are attached to sill 6 to complete the finished look.

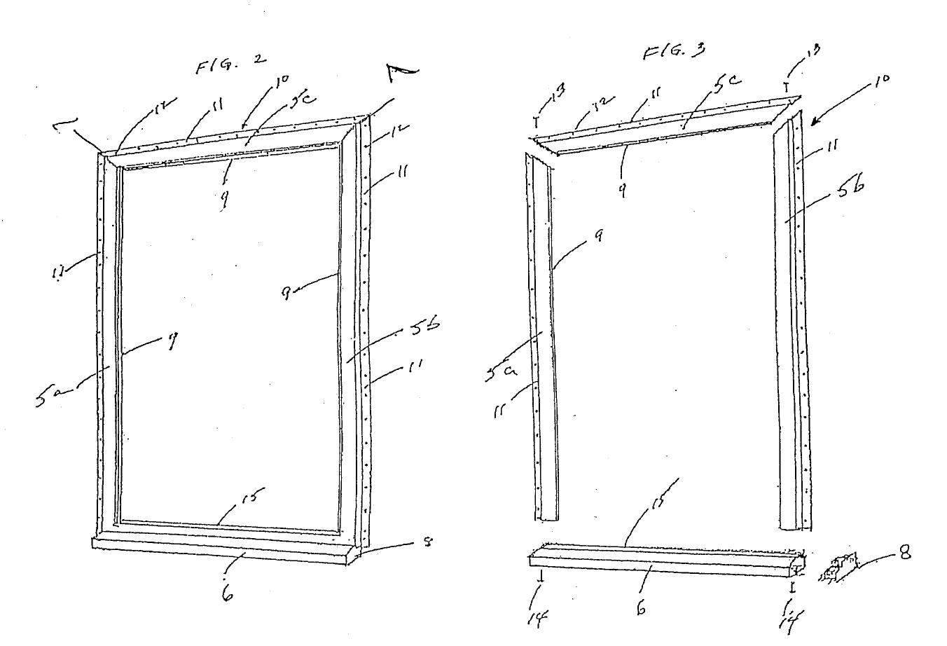

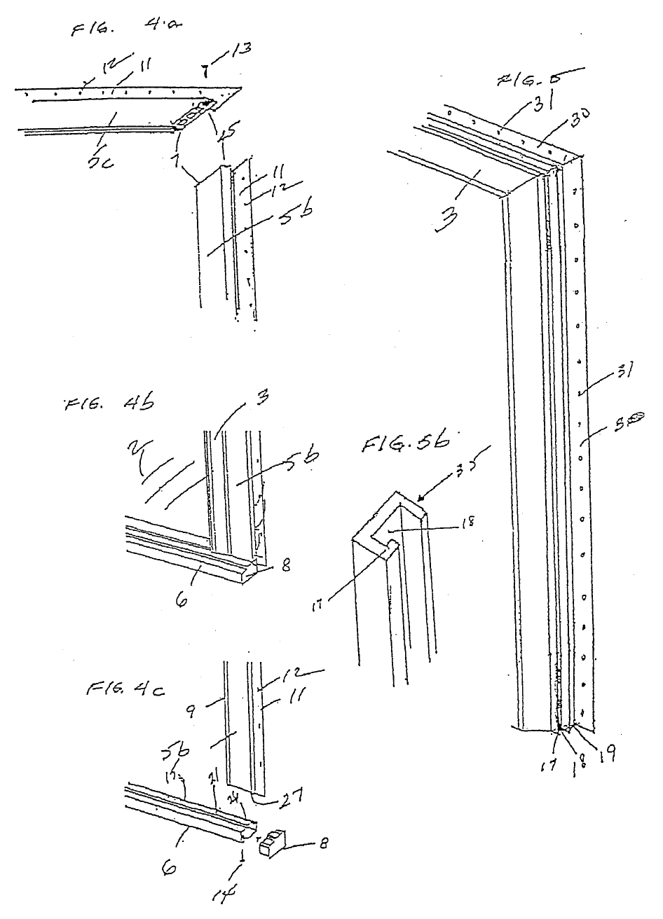

As seen in FIGS. 3, 4a, 4b and 4c, a complete window casing 10 is comprised of few components and is easily assembled and mounted on the window frame. In the preferred embodiment, after first installing the window and window frame 3 in the house in known fashion, nails or screws are driven through the nail slots 31 in the window nailing fin 30 as shown in FIG. 5 into the sheathing 16, to secure the installed window. Then, as shown in FIGS. 3 and 4a, the pre-mitered ends 7 of side sections 5a and 5b are placed adjacent to the pre-mitered ends 7 of top casing section 5c and attached by screws 13 inserted in the top casing, preferably through predrilled holes, into receiving screw bosses 25 located in the side casings, creating a three-sided “horseshoe” shaped assembly. The horseshoe shaped assembly is then slidably mounted over the window frame 3, tongues 9 on the inside edges of the side sections 5a and 5b being first inserted in the accessory grooves 18 of the sides of the window frame 3 as shown in FIGS. 5, 10a and 10b, then tongue-in-groove, sliding the three-sided assembly down over the front of the window frame, the tongues 9 of the side casing sections assembly fitting into the accessory grooves 18 located on the sides of the window frame 3 until the tongue 9 of the top casing section 5c mates with and is seated in the accessory groove 18 of the top of the window frame. Referring to FIGS. 10a and 10b, in a preferred embodiment, nailing fin 11 of the side and top casings 5a, 5b and 5c is in the form of an L-shaped flange, portion 11a of the flange extends generally perpendicular from the back of the casing approximately ¾″ and the other portion 11b of L-shaped nailing fin 11 extends in a direction away from the window frame 3 generally parallel with exterior face of the casing so that potion 11b of nailing fin 11 lies essentially flush with the underlayer or sheathing 16 of the house. Portion 23a of second L-shaped flange 23, extends generally perpendicular from the back of the casing approximately ¾″ and the other portion 23b of said L-shaped flange 23 extends in a direction toward window frame 3 generally parallel with exterior face of the casing so that portion 23b of L-shaped flange lies in slot 19 essentially flush with the nailing fin 30 of the window frame providing further support for the casing on the window frame.

Once the three-sided assembly is in place, preferably, at least one nail or screw will be driven through nail slots 12 in each of the nailing fins 11 to hold the three-sided assembly in place on the window frame. As shown in FIGS. 3, 4b, 4c, 8a, 8b and 9, sill 6 is then raised upwards toward the bottom of the window frame 3 inserting sill tongue 15 into the accessory groove 18 on the bottom of the window frame 3 and snapping it onto place. Preferably, sill tongue 15 is notched or flanged and lockingly engages flexible accessory lock 17 on the window frame. As shown in FIGS. 4b and 4c, the bottoms 27 of the side casings 5a and 5b seat flat on sill 6 at meeting places 26, behind the step 21 of the sill, which may be tapped into place with a mallet, if necessary. End caps 8 are fitted into the sides of the sill section 6. The sill 6 is then secured to the side casings 5a and 5b with screws 14 inserted in the sill and received in screw bosses 25 located in the side casings. Preferably the sill 6 should have pre-drilled holes 32 to accommodate screws 14. The completed casing 10 is then secured to the side of the house with nails, screws or staples being driven through nail holes 12 in nailing fins 11. Thereafter, siding 1 is then installed on the house in known fashion, the portion of the siding that lies adjacent to the window frame and casing being cut to fit snugly between the casing J-channel in recess 33 formed by the back of the casing and L-shaped section 11.

Referring to FIG. 5 is shown a portion of the top and sides sections window frame 3, nailing fin 30 and nail slots 31 for securing the window frame to the house and accessory groove 18 for receiving tongue 9 of the window casing and flexible accessory lock 17 to lockingly engage the tongue 9. Sill tongue 15 of sill 6 is similarly received in accessory groove 18 of the bottom section of the casing. It will be understood that not all window frames will have accessory groves. This particularly will be the case in older construction where the original windows and window frames are not being replaced. In order to use the casing system of the present invention with these older style windows, a pre-fabricated structure having an accessory groove can be installed around the periphery of the window frame to accommodate the casing. Such a device 35 as shown in FIG. 5b, is essentially a C-shaped member and includes accessory groove 18 and J-channel 17 and may be made of materials such as extruded vinyl or aluminum, for example. Device 35 may be affixed to the window frame in a conventional manner, such as by use of nails, screws or staples.

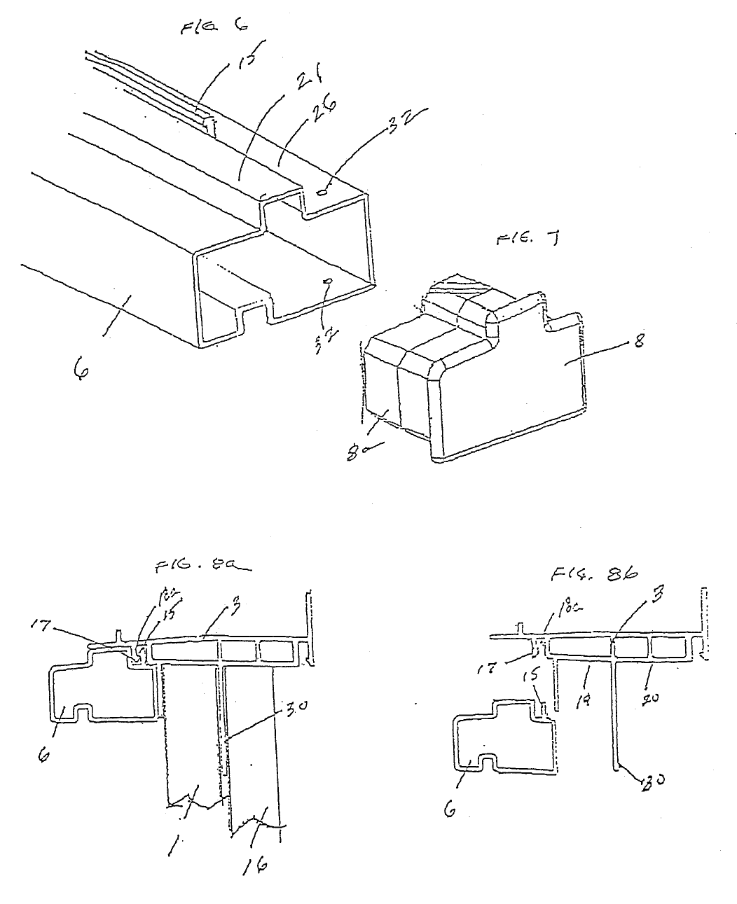

One side of sill 6 and end cap 8 are shown in greater detail in FIGS. 6 and 7. The sill 6 includes sill tongue 15 which is inserted in accessory groove 18 of the bottom section of the window frame 3. In the preferred embodiment, sill tongue 15 has a notch or flange at one end which lockingly engages a J-channel 17 in the said accessory groove. As can be seen in FIG. 6, sill tongue 15 is recessed inwardly from the side of sill 6 to enable the bottom 27 of the side casing sections 5a, 5b to seat flat on sill 6 at meeting place 26, behind the step 21 extending upward from the sill. Preferably, the meeting place 26 is approximately the width of the side casing sections 5a, 5b which are maintained in place between the rear side of the step 21 and the exterior of the siding 1 of the house. The end caps 8 may be made of the same material as the sill and are sized and configured to fit securely in the opposite sides of the sill section 6. As is also shown in FIG. 3, 4b and 4c, screws 14 are then inserted through pre-drilled holes 32 in the sill and pre-drilled holes 33 in the end caps and received in screw bosses 25 in the side casings 5a and 5b.

In addition to utilizing the casing as described in connection with windows, the casing of the present invention may be used in connection with doors, passageways, or any other type of opening in a structure. Further, the casing system of the present invention is not limited to four-sided openings, and may be utilized in archways calling for a curved trim, a one-piece ornamental header, a multi-sided window or other structure, and may be prefabricated or cut at the site.

Although described in terms of the presently preferred embodiment, those skilled in the art will appreciate that the present invention is not limited to the embodiment described.

What is claimed is:

1. A window or door casing kit comprising, elongated panels mountable on a window or door frame on at least three sides, said panels including a tongue on the inside edge and a nailing fin on the outside edge and an integral “J” channel, wherein the tongues of said panels are sized and shaped to engage grooves on the sides of the window or door frame.

2. A kit as claimed in claim 1, wherein the casing is securely fastened to the side of a house.

3. A kit as claimed in claim 1, wherein the panels have pre-mitered ends.

4. A kit as claimed in claim 1, wherein the casing is comprised of extruded vinyl.

5. A kit as claimed in claim 1, wherein the panels include a fastening system incorporating a screw boss.

6. A kit as claimed in claim 1, wherein the window or door frame includes a flexible accessory lock on the sides of the window frame.

7. A kit as claimed in claim 1, wherein the panels are pre-cut to size.

8. A kit as claimed in claim 1, wherein the panels are cut to size at the site.

9 A kit as claimed in claim 3, wherein the pre-mitered ends are at 45° angles.

10. A kit as claimed in claim 3, wherein the pre-mitered ends vary from 0-90°.

11. A kit as claimed in claim 1, wherein, upon mounting to a structure, the nailing fins sit flush against the sheathing or other underlayer of the house and nails, screws or staples are driven through slotted holes extending through the nailing fins to secure the casing to the house.

12. A kit as claimed in claim 1, wherein the tongues of the panels include a flange or notch.

13. A kit as claimed in claim 1, wherein, upon mounting to a structure, the nailing fin on the panels is in the form of an L-shaped flange, one portion of said flange extending generally perpendicular from the back of the casing and the integral “J” channel and another portion of said L-shaped flange extends in a direction generally parallel with an exterior face of the casing away from said window frame and lies essentially flush with the underlayer or sheathing of the house.

14. A kit as claimed in claim 1, wherein, upon mounting to a structure, a portion of an L-shaped flange extends generally perpendicular from the back of the casing and another portion of said L-shaped flange extends generally parallel with an exterior face of the casing toward said window frame and lies essentially flush with the nailing fin of the window frame.

15. A kit as claimed in claim 6, wherein the flexible accessory lock engages the tongue of the panels.

16. A kit as claimed in claim 1, wherein the panels include decorative millwork.

17. A window or door casing comprising, elongated panels mountable on a window frame or door frame on at least three sides, said panels including a tongue on the inside edge and a nailing fin on the outside edge, wherein the tongues of said panels engage grooves on the sides of the window or door frame, and a bottom section mountable on said window frame, said bottom section including a tongue of the inside edge, wherein the tongue of said bottom section engages a groove on the bottom of the frame, said side panel being fastened to the bottom section.

18. A window or door casing comprising an elongate member for attachment to the outer sides of a window or door frame, said elongate member having a groove, elongated panels mountable on said frame, said panels including a tongue on the inside edge and a nailing fin on the outside edge and a means for fastening said panels, whereby the tongues of said panels are sized and shaped to engage groove of said elongate member.

19. A window or door casing as claimed in claim 18, wherein said elongate member is C-shaped in cross-section.

20. A window or door casing as claimed in claim 18, wherein said elongate member includes a flexible accessory lock.

21. A window or door casing as claimed in claim 18, wherein elongate member device is made of extruded vinyl or aluminum.

22. A method for mounting a window or door casing to a building, comprising the steps of:
providing at least three elongated panels, said panels including a tongue on the inside edge and a nailing fin on the outside edge with tongues of said panels on the inside edge;
mating the ends of said panels to form in least two places to form a structure having at least three sides and at least one open end;
fastening the ends of the mated panels together;
sliding the structure over the front of a window or door frame, the tongues of the panels engaging grooves located on the sides of the window or door frame; and
driving nails, screws or staples through the nailing fins to secure the casing to the building.

23. A method for mounting a window or door casing to a building, comprising the steps of:
providing at least three elongated panels, said panels including a tongue on the inside edge and a nailing fin on the outside edge with tongues of said panels on the inside edge;
mating the ends of said panels to form in least two places to form a structure having at least three sides and at least one open end;
fastening the ends of the mated panels together;
attaching an elongate member to the outer sides of a window or door frame, said elongate member having a groove;
sliding the structure over the front of a window or door frame, the tongues of the panels engaging grooves located on said elongate member; and
driving nails, screws or staples through the nailing fins to secure the casing to the building.

24. A method for mounting a window or door casing to a building, comprising the steps of:
providing at least three elongated panels, said panels including a tongue on the inside edge and a nailing fin on the outside edge with tongues of said panels on the inside edge;
mating the ends of said panels to form in least two places to form a structure having at least three sides and at least one open end;
fastening the ends of the mated panels together;
sliding the structure over the front of a window or door frame, the tongues of the panels engaging grooves located on the sides of the window or door frame;
driving at least one nail, screw or staple through each nailing fin;
arranging a bottom section having a tongue on the inside edge adjacent to the bottom of the window or door frame, whereby the tongue of said bottom section engages a groove on the bottom of the window or door frame with a portion of at least two panels adjacent to the bottom section in at least two places;
inserting end caps in the sides of the bottom section;
fastening the bottom section and the end caps to said adjacent panels; and
driving nails, screws or staples through the nailing fins to secure the casing to the building.
